(19) United States
(12) Patent Application Publication
(10) Pub. No.: US 2013/0155353 A1
(43) Pub. Date: Jun. 20, 2013

(54) LCD Panel and Manufacturing Method Thereof

(71) Applicants: Xiaolong Ma, Shenzhen (CN); Hong-Ji Huang, Shenzhen (CN); Hsiao-hsien Chen, Shenzhen (CN)

(72) Inventors: Xiaolong Ma, Shenzhen (CN); Hong-Ji Huang, Shenzhen (CN); Hsiao-hsien Chen, Shenzhen (CN)

(73) Assignee: Shenzhen China Star Opoelectronics Technology Co., Ltd., Shenzhen (CN)

(21) Appl. No.: 13/380,879

(22) PCT Filed: Dec. 19, 2011
(86) PCT No.: PCT/CN11/84183

§ 371 Date: Dec. 26, 2011

(30) Foreign Application Priority Data
Dec. 15, 2011 (CN) 201110419814.5

(51) Int. Cl. G02F 1/1335; H01J 9/24

(52) U.S. Cl. 349/106; 445/24

(57) ABSTRACT

A liquid crystal display (LCD) panel including a color filter on array (COA) substrate and a manufacturing method thereof are proposed. Metallic layers of the substrate of the LCD panel replace a conventional black matrix and are used for blocking light so the occurrence of color mixing and light leakage is prevented. Since the conventional black matrix is unnecessary in the present invention, the process steps of forming the LCD panel are simplified. Not only yield rate is raised, but also cost is reduced.

### BACKGROUND OF THE INVENTION

1. Field of the Invention

The present invention relates to a liquid crystal display (LCD) panel and a manufacturing method thereof, and more particularly, to an LCD panel of using metallic layers to replace a conventional black matrix and a manufacturing method thereof.

2. Description of the Prior Art

An advanced monitor with multiple functions is an important feature for use in current consumer electronic products. Liquid crystal displays (LCDs) which are colorful monitors with high resolution are widely used in various electronic products such as monitors for mobile phones, personal digital assistants (PDAs), digital cameras, laptop computers, and notebook computers.

A conventional LCD panel comprises a color filter, a thin film transistor array substrate (TFT array substrate), and a liquid crystal layer placed between the color filter and the TFT array substrate. The conventional LCD panel has shortcomings as follows: the resolution of the LCD panel is worse; the aperture ratio of pixels is lower; misalignment occurs easily when the color filter and the TFT array substrate are assembled.

With recent progress in display technology, technology that a color filter is directly incorporated with a color filter on array (COA) substrate and that a black matrix is directly fabricated on a black matrix on array (BOA) substrate is proposed. The aforesaid COA substrate or the BOA substrate and an opposite substrate which does not comprise the color filter or the black matrix together form an LCD panel. Liquid crystal molecules are sandwiched between the opposite substrate and the COA substrate or the BOA substrate. Since the color filter is directly formed on the TFT array substrate, misalignment will not occur. Moreover, such an LCD panel has advantages of high resolution and a high aperture ratio.

FIG. 1 shows a simplified cross-section diagram of an LCD panel 100 in a conventional technology. The LCD panel 100 is an LCD panel comprising a BOA substrate; that is, a color filter 130 is directly formed on a glass substrate 110 of the LCD panel 100. As shown in FIG. 1, the LCD panel 100 comprises the glass substrate 110, a black matrix 120, and the color filter 130.

It is notified that, the LCD panel 100 comprises metallic layers used for forming data lines and scan lines, an insulating layer, a protection layer, etc., between the color filter 130 and the glass substrate 110 though these elements are not shown in FIG. 1. The function and structure of the elements is understood by persons skilled in the relevant art, so no explanations in more detail are given below.

Continuing referring to FIG. 1, the color filter 130 is used for filtering light. Light becomes visible light having a specific color after being color filtered by the color filter 130. In this embodiment, light is color filtered by red, blue, and green color filters 131, 132, and 133, and red light, blue light, green light pass through, respectively. Light with diverse colors is obtained after combining light with the three primary colors. Accordingly, images are shown on the LCD panel 100.

In addition, the black matrix 120 is placed between every two color filters 130 and is used for blocking light generated by a backlight module to prevent light from travelling through a plurality of color filters 130 falsely, thereby preventing color mixing and light leakage.

Referring to FIG. 2, FIG. 2 is a simple cross-section diagram of an LCD panel 200 in another conventional technology. The structure of the LCD panel 200 in FIG. 2 is basically similar to that of the LCD panel 100 in FIG. 1. Elements having the same function and structure are designated by the same reference numerals though they are shown in FIG. 1 and in FIG. 2, and explanations in more detail will not be given below. It is notified that, an overcoat 210 is additionally deposited on the color filter 120 as shown in FIG. 2. The overcoat 210 is used for reducing the difference of the height of the substrate to allow the substrate to become flatter. The difference of the height of the substrate causes poor orientation of the liquid crystal molecules, resulting in light leakage.

Today's LCD panels are manufactured using several process steps. The cost of manufacturing LCD panels will be greatly reduced if the black matrix is not used.

### SUMMARY OF THE INVENTION

Therefore, an object of the present invention is provide an LCD panel of using metallic layers to replace a conventional black matrix and a manufacturing method thereof. The present invention can effectively reduce cost and cut process steps.

According to the present invention, a method of a liquid crystal display (LCD) panel comprising a color filter on array (COA) substrate is provided. The method comprises the steps of: providing a glass substrate; forming a first metallic layer on the glass substrate and etching the first metallic layer for forming a scan line, a gate of a thin film transistor (TFT), and a bottom electrode of a storage capacitor; depositing an insulting layer on the glass substrate and on the first metallic layer; depositing an active layer and an n+ layer on the insulting layer; etching the active layer and the n+ layer for defining the TFT, and the active layer being used as a passage of the TFT; depositing a second metallic layer on the n+ layer and on the insulating layer, etching the second metallic layer for forming a data line, and defining a source and a drain of the TFT on the n+ layer; depositing a passivation layer on the second metallic layer and on the insulating layer; etching the passivation layer for forming a first via on the drain of the TFT and forming a second via on top of the bottom electrode of the storage capacitor; depositing a color filter on the passivation layer and etching the color filter for forming a plurality of color filters; and depositing a transparent conducting layer on the color filter, coupling the transparent conducting layer to the drain of the TFT through the first via, and forming a top electrode of the storage capacitor on the second via wherein the first and second metallic layers are used for blocking light.

In one aspect of the present invention, the method further comprises a step of: depositing an overcoat on the transparent conducting layer.

In another aspect of the present invention, the plurality of color filters comprise a red color filter, a green color filter, and a blue color filter.

According to the present invention, a method of manufacturing an LCD panel having a COA substrate is provided. The method comprises the steps of: providing a glass substrate; forming a scan line, a TFT, a data line, and a bottom electrode of a storage capacitor; depositing a passivation layer and etching the passivation layer to form a first via on a drain of the TFT and forming a second via on top of the bottom electrode of the storage capacitor; depositing a color filter on the passivation layer and etching the color filter to form a plurality of color filters; and depositing a transparent conducting layer on the color filter, coupling the transparent conducting layer to the drain of the TFT through the first via, and forming a top electrode of the storage capacitor on the second via. A projection of the data line or the scan line placed between every two neighboring color filters on the glass substrate is overlapped with a projection of every two neighboring color filters on the glass substrate.

In one aspect of the present invention, the method further comprises: depositing an overcoat on the transparent conducting layer.

In another aspect of the present invention, the plurality of color filters comprise a red color filter, a green color filter, and a blue color filter.

According to the present invention, an LCD panel comprises a glass substrate; a first metallic layer, placed on the glass substrate, for forming a scan line, a gate of a TFT, and a bottom electrode of a storage capacitor; an insulating layer, placed on the glass substrate and on the first metallic layer; an active layer, placed on the insulating layer, for being used as a passage of the TFT; an n+ layer, placed on the active layer; a second metallic layer, placed on the n+ layer and on the insulating layer, for being used as a data line and a source and a drain of the TFT; a passivation layer, placed on the second metallic layer and on the insulating layer; a color filter, placed on the passivation layer, comprising a plurality of color filters, wherein a projection of the data line or the scan line placed between every two neighboring color filters on the glass substrate is overlapped with a projection of every two neighboring color filters on the glass substrate; and a transparent conducting layer, placed on the color filter, coupled to the drain of the TFT, and used as a top electrode of the storage capacitor. The first and second metallic layers are used for blocking light.

In one aspect of the present invention, the LCD panel further comprises an overcoat, placed on the transparent conducting layer.

In another aspect of the present invention, the plurality of color filters comprise a red color filter, a green color filter, and a blue color filter.

In contrast to the conventional technology, the black matrix is replaced by metallic layers which serve as data lines or scan lines in the present invention. Because the process step of using the black matrix is skipped, the process steps of forming the LCD panel are simplified. Not only yield rate is raised, but also cost is reduced.

These and other features, aspects and advantages of the present disclosure will become understood with reference to the following description, appended claims and accompanying figures.

### BRIEF DESCRIPTION OF THE DRAWINGS

FIG. 1 shows a simplified cross-section diagram of an LCD panel in a conventional technology.

FIG. 2 is a simple cross-section diagram of an LCD panel in another conventional technology.

FIG. 3 shows a schematic diagram of an LCD panel according to an embodiment of the present invention.

FIGS. 4A-4C to 9A-9C illustrate processes for forming the LCD panel as shown in FIG. 3.

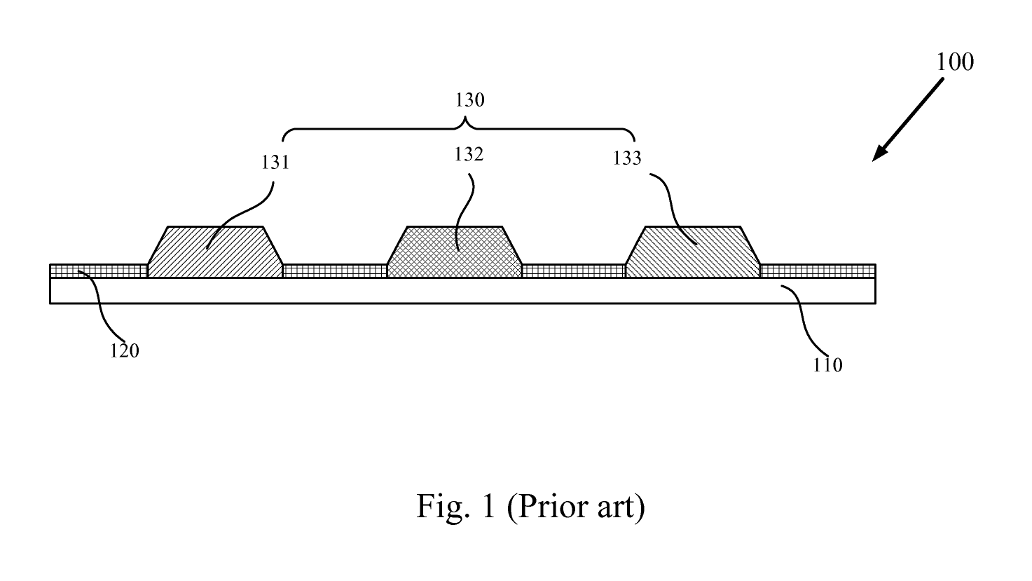

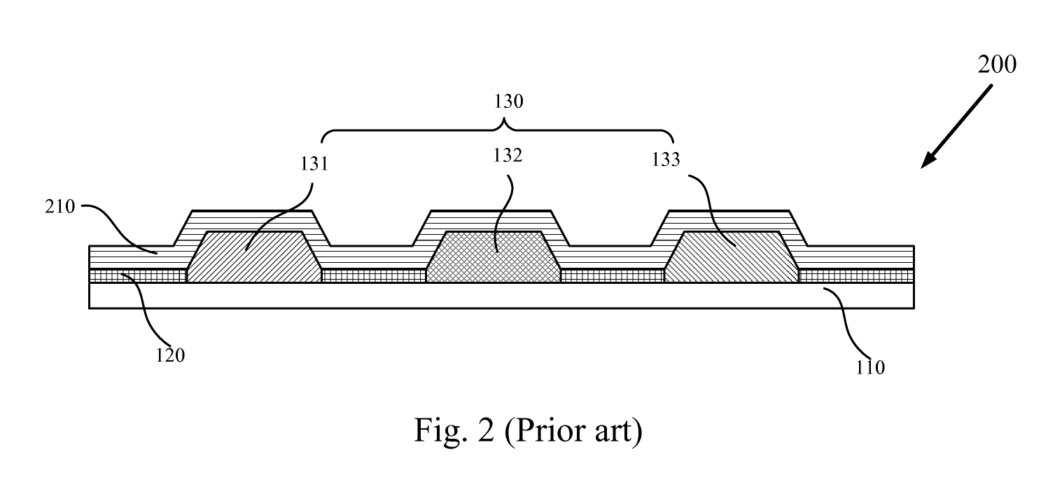

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

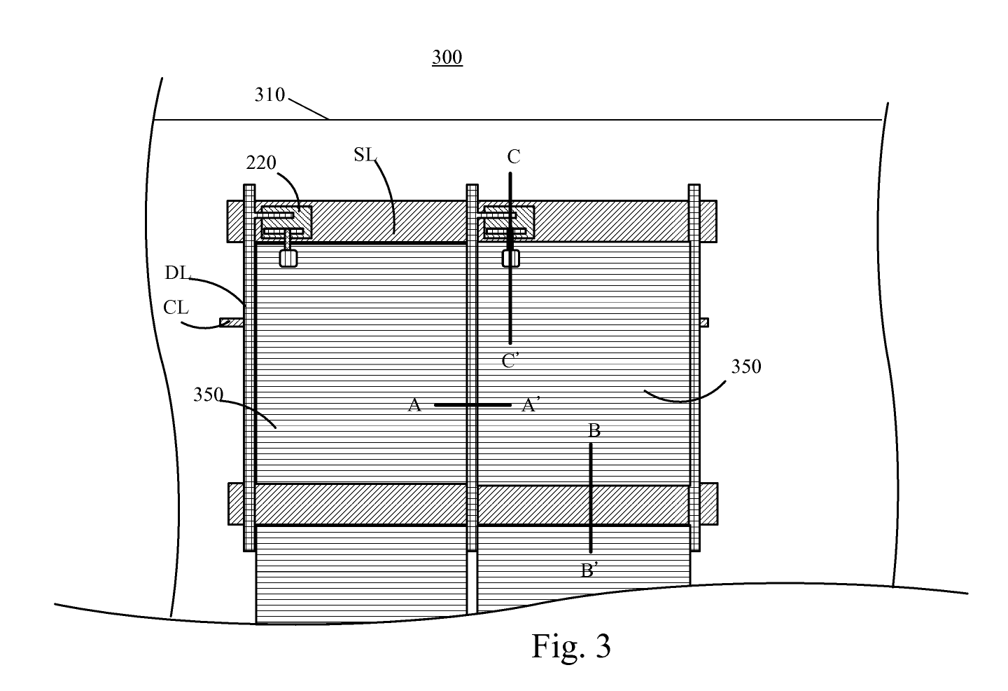

Referring to FIG. 3, FIG. 3 shows a schematic diagram of an LCD panel 300 according to an embodiment of the present invention. The LCD panel 300 comprises a glass substrate 310, a plurality of scan lines SL, a plurality of data lines DL, a plurality of TFTs 220, a plurality of common electrodes CL, and a plurality of pixel electrodes 360. The plurality of scan lines SL, the plurality of data lines DL, and the plurality of TFTs 220 all are disposed on the glass substrate 310. The plurality of scan lines SL and the plurality of data lines DL are alternatively arranged, which forms a matrix-arranged pixel area. Each of the plurality of TFTs 220 is electrically connected to a pixel electrode 360, a scan line SL, and a data line DL.

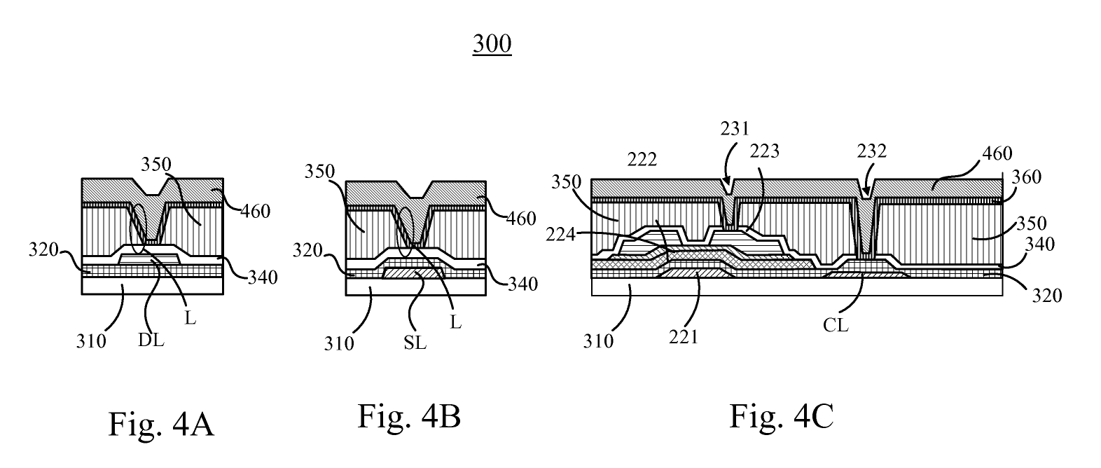

Referring to FIG. 3 and FIGS. 4A-4C, FIGS. 4A-4C show cross-section views of the LCD panel 300 taken along lines A-A′, B-B′, and C-C′ of FIG. 3. As shown in FIGS. 4A-4C, the LCD panel 300 comprises the glass substrate 310, an insulating layer 320, a TFT 220, a passivation layer 340, and a plurality of color filters 350. The LCD panel 300 is an LCD panel comprising a COA substrate; that is, the plurality of color filters 350 and the TFT 220 all are formed on the same glass substrate 310. The scan lines SL, a gate 221 of the TFT 220, and the common electrode CL all are disposed on the glass substrate 310 and all are formed by the same first metallic layer. The insulating layer 320 is placed on the glass substrate 310 and on the first metallic layer. An active layer 541 is placed on the insulating layer 320 and is used as a channel 224 of the TFT 220. An n+ layer 542 is placed on the active layer 541. A second metallic layer is placed on the n+ layer 542 and on the insulating layer 320 and is used as the data line DL and a source 222 and a drain 223 of the TFT 220. The passivation layer 340 is placed on the second metallic layer and on the insulating layer 320. The plurality of color filters 350 are disposed on the passivation layer 340. An overcoat 460 is placed on the plurality of color filters 350 and is used for making the top of the plurality of color filters 350 be flattened. In this way, light leakage occurring due to disclination of the liquid crystal molecules is avoided. A transparent conducting layer (i.e. a pixel electrode) 360 is placed on the overcoat 460 and is coupled to the drain 223 of the TFT 220. The transparent conducting layer 360 also serves as a top electrode of a storage capacitor.

The plurality of color filters 350 comprise a red color filter, a blue color filter, and a green color filter for filtering respective wavelengths of light, e.g. red light, blue light, and green light. Mixtures of red light, blue light, and green light may appear various colors. Because the plurality of data lines DL and the plurality of scan lines SL are arranged perpendicularly and alternatively, a pixel matrix is formed on the LCD panel 300. The plurality of data lines DL and the plurality of scan lines SL are disposed between every two neighboring color filters 350. The plurality of data lines DL and the plurality of scan lines SL can effectively block light. In addition, each of the plurality of color filters 350 forms a trapezoid-like inclined angle L when being formed, resulting in disclination of the liquid crystal molecules in areas of the inclined angles L, thereby leading to light leakage. The projection of one of the data lines DL and one of the scan lines SL placed between every two neighboring color filters 350 on the glass substrate 310 is overlapped with that of every two neighboring color filters 350 on the glass substrate 310. Since the plurality of data lines DL and the plurality of scan lines SL all are made of metal, they are good at blocking light. Each data line DL or each scan line SL overlapping the color filters 350 can effectively prevent not only light leakage between every two neighboring color filters 350 but also light leakage resulting from disclination of liquid crystal molecules. Moreover, the overlapping area can successfully suppress color mixing among the plurality of color filters 350.

It is notified that, the plurality of data lines DL and the plurality of scan lines SL replace the black matrix used for preventing light leakage and color mixing from occurring in the present invention. In other words, light leakage and color mixing do not occur even though the black matrix is not used. As can be seen, the process steps of forming the LCD panel 300 are simplified in the present invention. Not only yield rate is raised, but also cost is reduced.

Referring to FIGS. 4A-4C to 9A-9C, FIGS. 4A-4C to 9A-9C illustrate processes for forming the LCD panel 300 as shown in FIG. 3.

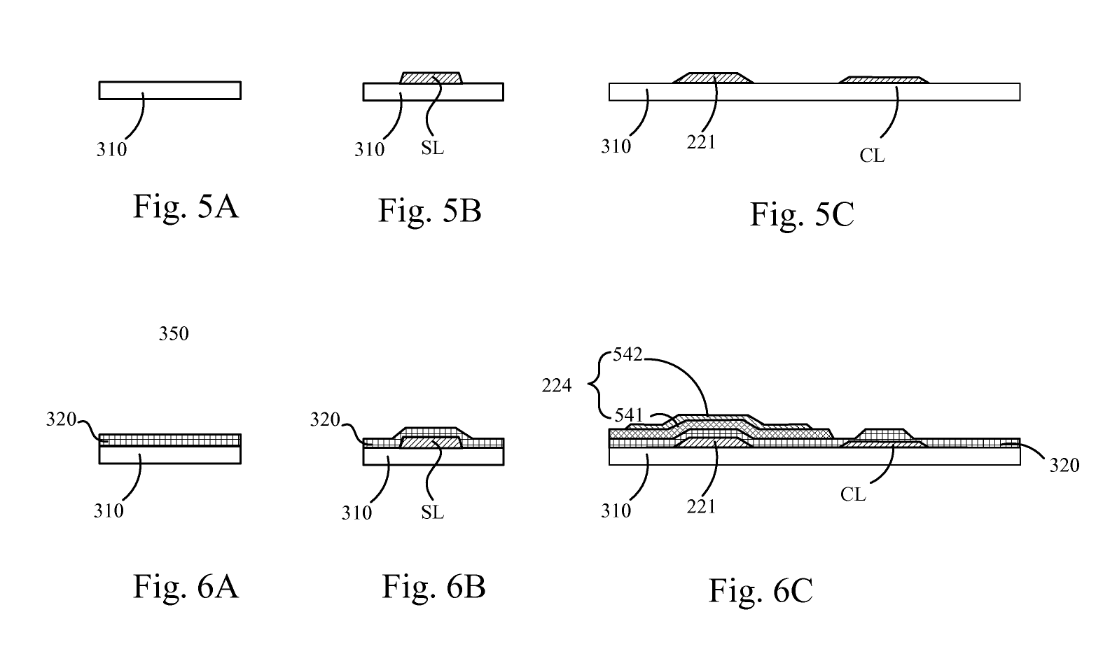

Referring to FIGS. 5A-5C, firstly, a first metallic layer is formed on a glass substrate 310. Then, the first metallic layer is etched for forming a plurality of scan lines SL, a gate 221 of a TFT 220, and a plurality of common electrodes CL used as a bottom electrode of a storage capacitor.

Referring to FIGS. 6A-6C, next, an insulating layer 320 is deposited on the glass substrate 310 and on the first metallic layer. Then, an active layer 541 and an n+layer 542 are deposited on the insulating layer 320. Then, the active layer 541 and the n+layer 542 are etched to define a passage 224 of the TFT 220.

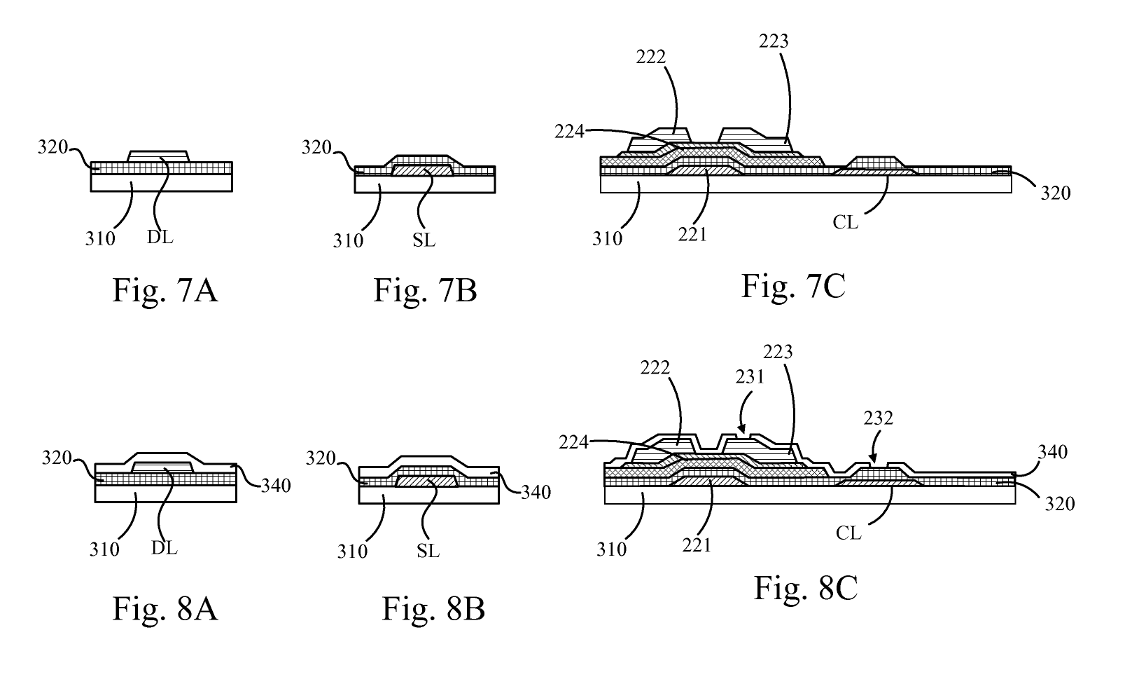

Referring to FIGS. 7A-7C, next, a second metallic layer (M2) 532 is deposited on the n+ layer 542 and on the insulating layer 320. Then, the second metallic layer (M2) 532 is etched for forming a plurality of data lines DL. A source 222 and a drain 223 of the TFT 220 are defined on the n+ layer 542.

Referring to FIGS. 8A-8C, next, a passivation layer 340 is deposited on the n+ layer 542 and on the insulating layer 320. Then, the passivation layer 340 is etched for forming a first via 231 on the drain 223 and a second via 232 on the plurality of common electrodes CL.

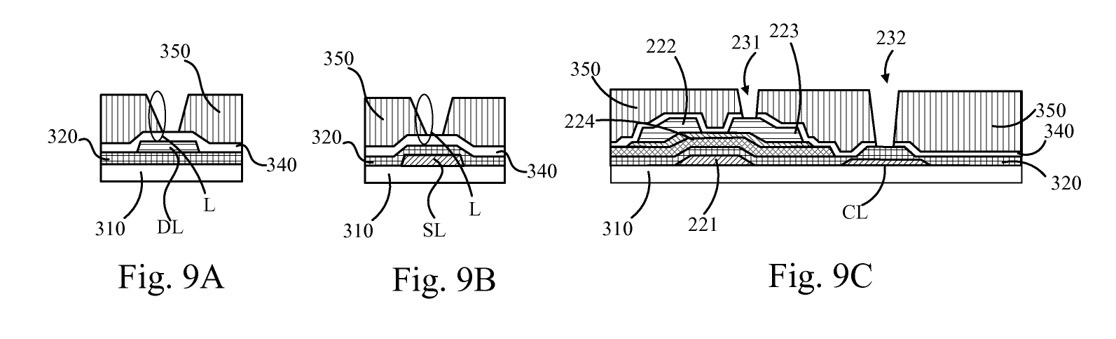

Referring to FIGS. 9A-9C, next, a color filter is deposited on the passivation layer 340. Then, the color filter is etched for forming a plurality of color filters 350.

Referring to FIGS. 4A-4C, next, an overcoat 460 is deposited on the plurality of color filters 350. Then, a transparent conducting layer 360 is deposited on the overcoat 460. The transparent conducting layer 360 is coupled to the drain 223 of the TFT 220 through the first via 231. The transparent conducting layer 360 forms a top electrode of the storage capacitor on the second via 232. The projection of the plurality of data lines DL and the plurality of scan lines SL disposed between every two neighboring color filters 350 on the glass substrate 310 is overlapped with that of every two neighboring color filters 350 on the glass substrate 310. The plurality of data lines DL and the plurality of scan lines SL all are made of metal for blocking light.

So far, the LCD panel 300 is almost done, and persons skilled in the art should understand the following process steps of completing the LCD panel 300. No explanations in more detail will be given below.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A method of manufacturing a liquid crystal display (LCD) panel comprising a color filter on array (COA) substrate, the method comprising:
providing a glass substrate;
forming a first metallic layer on the glass substrate and etching the first metallic layer for forming a scan line, a gate of a thin film transistor (TFT), and a bottom electrode of a storage capacitor;
depositing an insulting layer on the glass substrate and on the first metallic layer;
depositing an active layer and an n+ layer on the insulting layer;
etching the active layer and the n+ layer for defining the TFT, and the active layer being used as a passage of the TFT;
depositing a second metallic layer on the n+ layer and on the insulating layer, etching the second metallic layer for forming a data line, and defining a source and a drain of the TFT on the n+ layer;
depositing a passivation layer on the second metallic layer and on the insulating layer;
etching the passivation layer for forming a first via on the drain of the TFT and forming a second via on top of the bottom electrode of the storage capacitor;
depositing a color filter on the passivation layer and etching the color filter for forming a plurality of color filters; and
depositing a transparent conducting layer on the color filter, coupling the transparent conducting layer to the drain of the TFT through the first via, and forming a top electrode of the storage capacitor on the second via wherein the first and second metallic layers are used for blocking light.

2. The method as claimed in claim 1, further comprising a step of: depositing an overcoat on the transparent conducting layer.

3. The method as claimed in claim 1, wherein the plurality of color filters comprise a red color filter, a green color filter, and a blue color filter.

4. A method of manufacturing an LCD panel comprising a COA substrate, comprising:
providing a glass substrate;
forming a scan line, a TFT, a data line, and a bottom electrode of a storage capacitor;
depositing a passivation layer and etching the passivation layer to form a first via on a drain of the TFT and forming a second via on top of the bottom electrode of the storage capacitor;
depositing a color filter on the passivation layer and etching the color filter to form a plurality of color filters; and
depositing a transparent conducting layer on the color filter, coupling the transparent conducting layer to the drain of the TFT through the first via, and forming a top electrode of the storage capacitor on the second via;
wherein a projection of the data line or the scan line placed between every two neighboring color filters on the glass substrate is overlapped with a projection of every two neighboring color filters on the glass substrate.

5. The method as claimed in claim 4, further comprising: depositing an overcoat on the transparent conducting layer.

6. The method as claimed in claim 4, wherein the plurality of color filters comprise a red color filter, a green color filter, and a blue color filter.

7. An LCD panel, comprising:
a glass substrate;
a first metallic layer, placed on the glass substrate, for forming a scan line, a gate of a TFT, and a bottom electrode of a storage capacitor;
an insulating layer, placed on the glass substrate and on the first metallic layer;
an active layer, placed on the insulating layer, for being used as a passage of the TFT;
an n+ layer, placed on the active layer;
a second metallic layer, placed on the n+ layer and on the insulating layer, for being used as a data line and a source and a drain of the TFT;
a passivation layer, placed on the second metallic layer and on the insulating layer;
a color filter, placed on the passivation layer, comprising a plurality of color filters, wherein a projection of the data line or the scan line placed between every two neighboring color filters on the glass substrate is overlapped with a projection of every two neighboring color filters on the glass substrate; and
a transparent conducting layer, placed on the color filter, coupled to the drain of the TFT, and used as a top electrode of the storage capacitor;
wherein the first and second metallic layers are used for blocking light.

8. The LCD panel as claimed in claim 7, wherein the LCD panel further comprises an overcoat, placed on the transparent conducting layer.

9. The LCD panel as claimed in claim 7, wherein the plurality of color filters comprise a red color filter, a green color filter, and a blue color filter.
